(19) United States
(12) Patent Application Publication
(10) Pub. No.: US 2014/0339300 A1
(43) Pub. Date: Nov. 20, 2014

(54) TICKET-TOKEN AND TICKET-CARD CAPABLE OF DISPLAYING INFORMATION OF PARKING TIME

(71) Applicant: Chien-Shuo CHEN, Taoyuan County (TW)

(72) Inventor: Chien-Shuo CHEN, Taoyuan County (TW)

(21) Appl. No.: 13/895,955

(22) Filed: May 16, 2013

(51) Int. Cl. G07C 1/30

(52) U.S. Cl. CPC G07C 1/30
USPC 235/378; 235/377

(57) ABSTRACT

A ticket-token and a ticket-card respectively have a displaying module. The displaying module is mounted on a token body or a card body. The displaying module has an indicator for displaying a parking time. When a user obtains the ticket-token or the ticket-card from a ticket machine, the user can know the parking time by viewing the indicator. Hence, the user can accurately know the parking time anytime during the parking duration for time management.

### BACKGROUND OF THE INVENTION

1. Field of the Invention

The present invention relates to a ticket-token and a ticket-card, and more particularly to a ticket-token and a ticket-card capable of displaying information of parking time.

2. Description of Related Art

Automatic car parking management system comprises a ticket machine situated on an entrance/exit of a parking garage or a parking lot. A user has to obtain a parking ticket from the ticket machine prior to driving into the parking garage or parking lot. The parking ticket can be a ticket-token or a ticket-card. The parking ticket stores information of parking time. Before the user drives the car to leave the parking garage or parking lot, the user has to return the parking ticket to the ticket machine. When the ticket machine receives the parking ticket, the ticket machine calculates and displays a parking fee according to a parking duration and a parking rate, such that the user pays the parking fee at the ticket machine. After the parking fee is paid at the ticket machine, the ticket machine enters a pass command to the parking ticket and returns the parking ticket to the user. When the user obtains the parking ticket with the pass command, the user can insert the parking ticket to a ticket recycler. Afterward, the driver can drive the car to leave the parking garage or parking lot.

With reference to FIGS. 7 and 8, a conventional ticket-token 81 has a storage module 82. The storage module 82 has a coil 821 and a chip 822. When the ticket machine provides the ticket-token 81 to the user, the ticket machine generates a wireless RF signal containing information of parking time to activate the coil 821, such that the ticket machine can write the parking time to the storage module 82. With reference to FIG. 9, a conventional ticket-card has a storage module 92. The storage module 92 can be a magnetic stripe. The ticket machine can write the parking time to the magnetic stripe.

However, the user cannot accurately know the parking time that is stored in the storage module 82, 92. The user does not know the exact parking fee until the ticket machine displays the parking fee. The user cannot check whether the parking fee calculated by the ticket machine is correct.

### SUMMARY OF THE INVENTION

An objective of the invention is to provide a ticket-token and a ticket-card. The ticket-token and the ticket-card can display the parking time for the user.

The ticket-token has:
a token body;
a storage module embedded in the token body and having:
   a coil inducing a detecting current according to a wireless RF signal containing information of parking time; and
   a chip electrically connected to the coil and storing the parking time according to the detecting current of the coil; and
a displaying unit mounted on the token body and having an indicator for displaying the parking time.

The ticket-card has:
a card body;
a storage module mounted on the card body for storing information of parking time; and
a displaying unit mounted on the card body and having an indicator for displaying the parking time.

For example, the displaying module can comprise an electronic paper or can be a thermal rewrite card. The electronic paper and the thermal rewrite card can display the parking time. Therefore, the user can check the parking time anytime within the parking duration for time management. When the user pays the parking fee, the user can confirm whether the parking fee calculated by the ticket machine is correct.

### BRIEF DESCRIPTION OF THE DRAWINGS

FIG. 1 is a perspective view of a first embodiment of the ticket-token of the invention;

FIG. 2 is a circuit block diagram of the storage module of the ticket-token in FIG. 1;

FIG. 3A is a circuit block diagram of the storage module and the displaying unit of a second embodiment of the ticket-token of the invention;

FIG. 3B is a circuit block diagram of the storage module and the displaying unit of a third embodiment of the ticket-token of the invention;

FIG. 4 is a plan view of the ticket-token of the invention;

FIG. 5 is a circuit block diagram showing a rechargeable battery is connected to the coil and the displaying unit of the ticket-token of the invention;

FIG. 6 is a plan view of a ticket-card of the invention;

FIG. 7 is a perspective view of a conventional ticket-token;

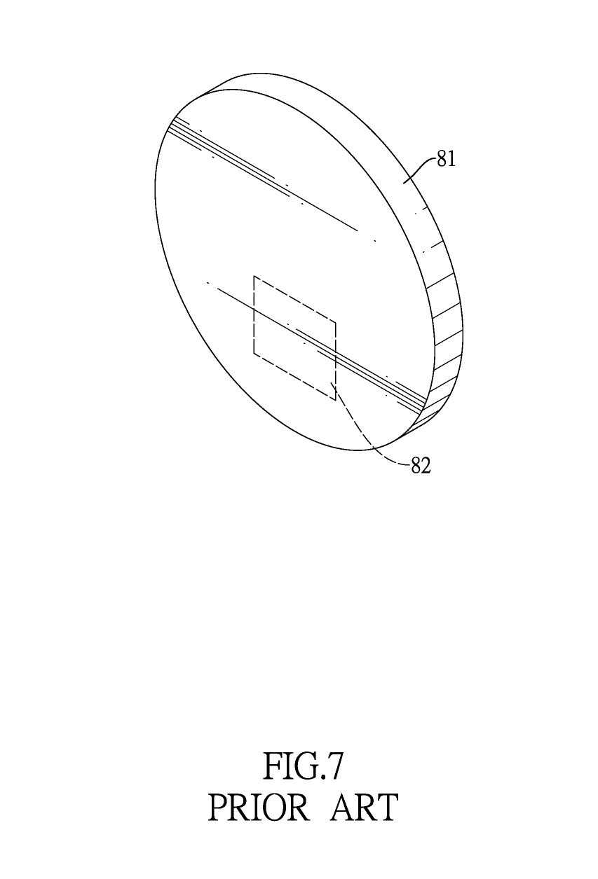

FIG. 8 is a circuit block diagram of a storage module of the conventional ticket-token; and

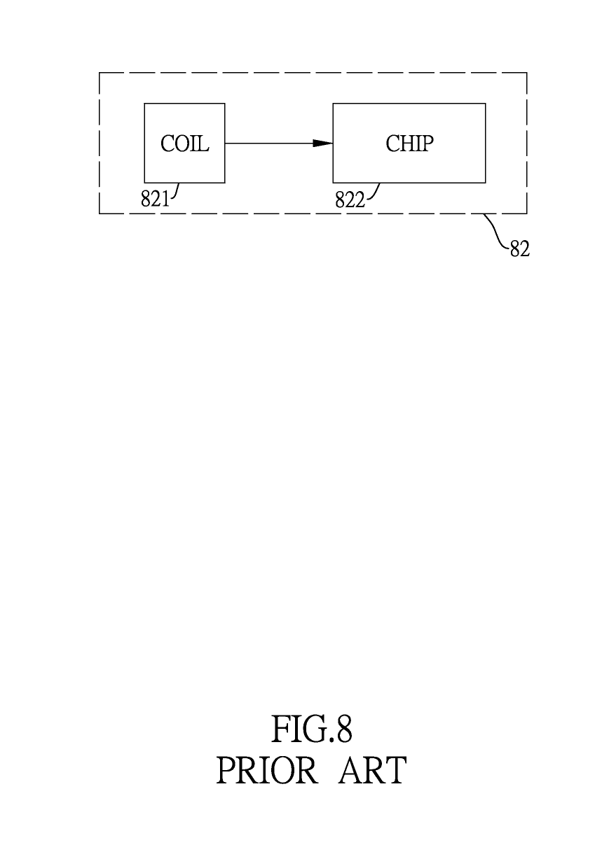

FIG. 9 is a conventional ticket-card.

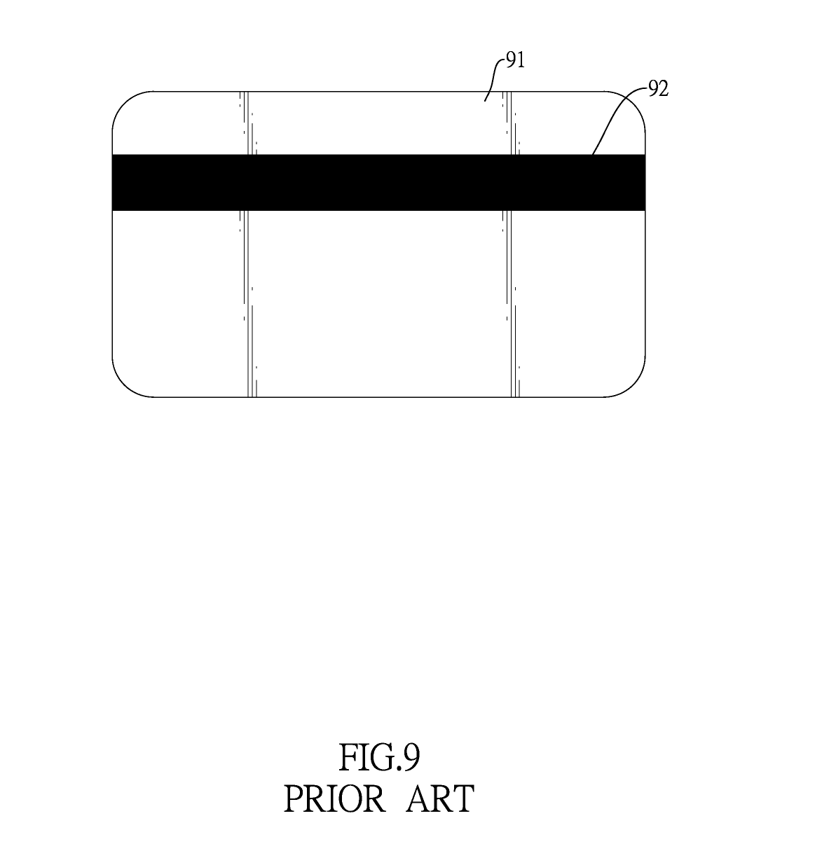

### DETAILED DESCRIPTION OF THE PREFERRED EMBODIMENT

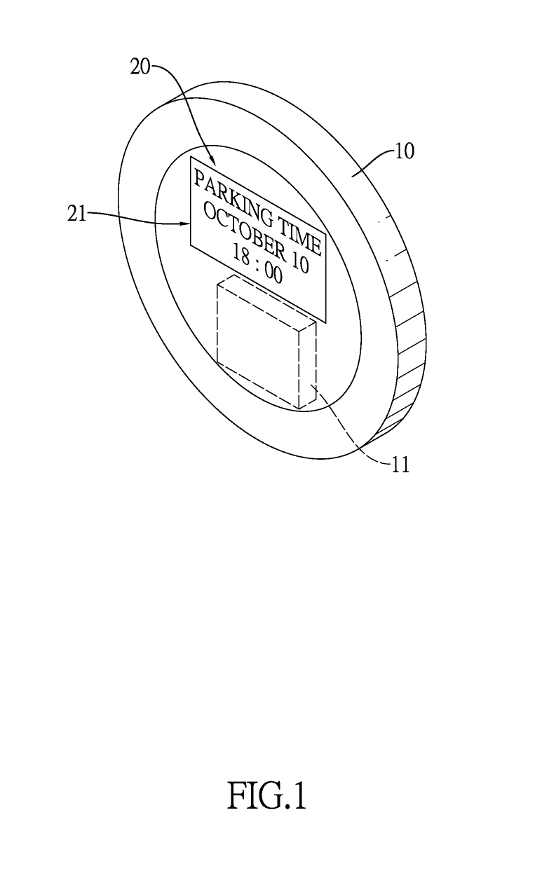

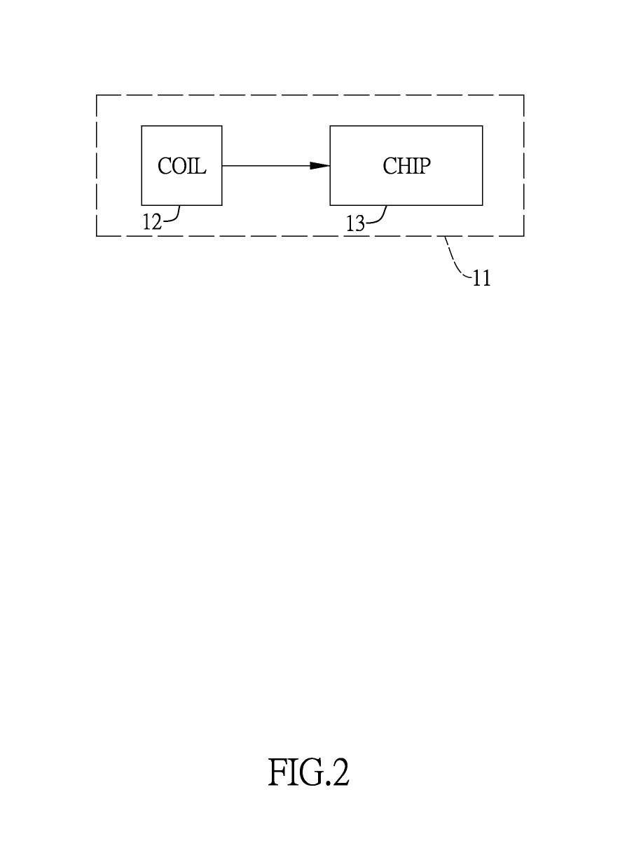

With reference to FIGS. 1 and 2, a first embodiment of the ticket-token of the invention comprises a token body 10, a storage module 11 and a displaying unit 20.

The storage module 11 is embedded in the token body 10 and has a coil 12 and a chip 13. The coil 12 induces a detecting current according to a wireless RF (radio frequency) signal containing information of parking date and parking time. The chip 13 is electrically connected to the coil 12 to receive the detecting current and to store the parking date and the parking time according to the detecting current.

The displaying unit 20 is mounted on the token body 10 and has an indicator 21 for displaying the parking date and the parking time. In the first embodiment, the displaying unit 20 can be a thermal rewrite card. A ticket machine has a printer to print the parking date and the parking time on the thermal rewrite card. The thermal rewrite card is made of thermally sensitive materials. Color of the thermal rewrite card is reversible according to temperature, such that the printer can erase pervious parking information and write new parking information to the thermal rewrite card.

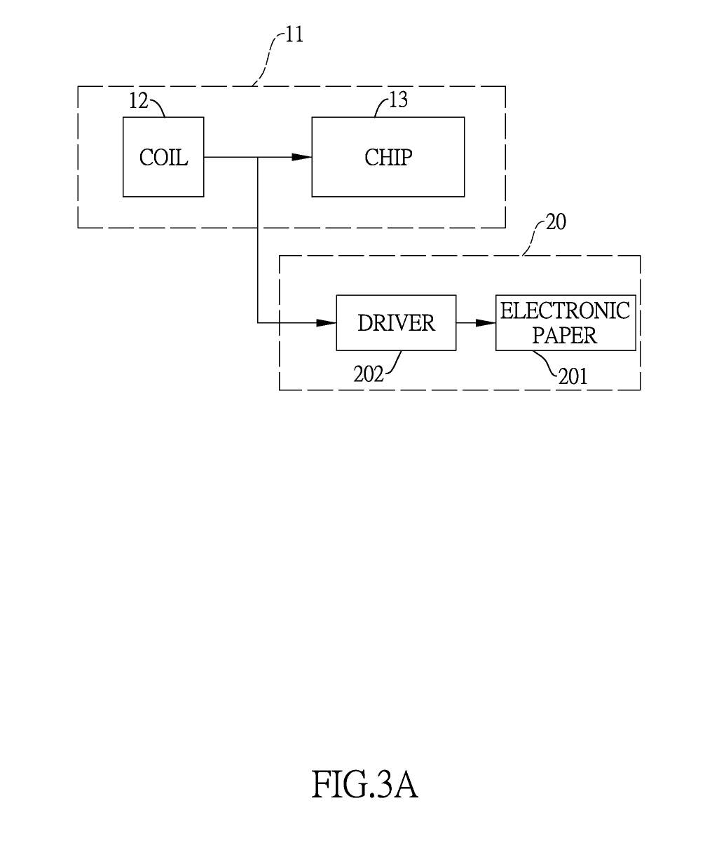

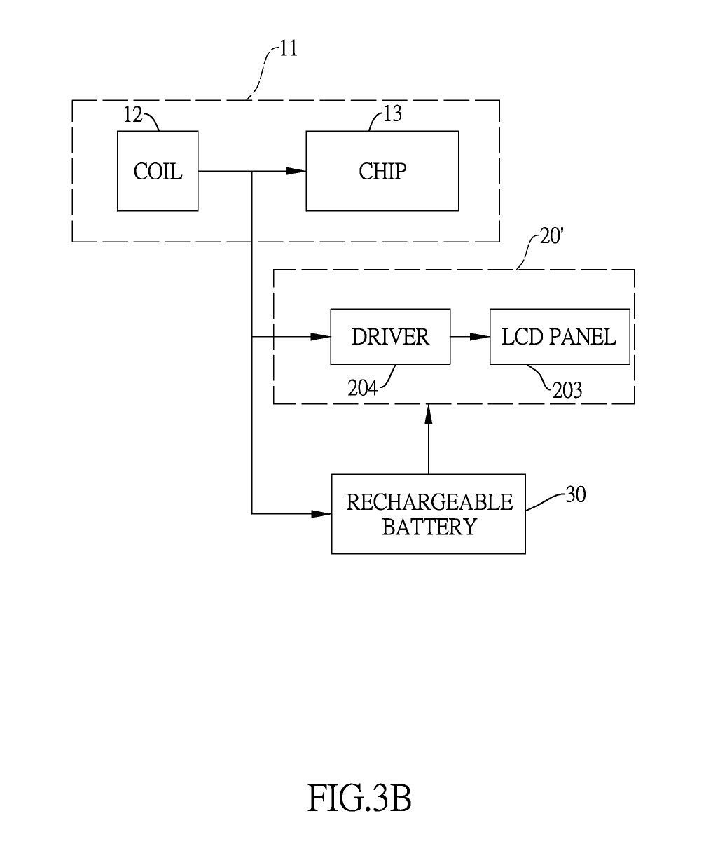

With reference to FIG. 3A, in a second embodiment, the displaying unit 20 comprises an electronic paper 201 and a driver 202. The electronic paper 201 acting as the indicator 21 is mounted on the token body 10. The driver 202 is embedded in the token body 10 and is electrically connected to the electronic paper 201 and the coil 12. When the coil 12 induces the detecting current, the driver 202 acquires the information of parking date and time and activates the electronic paper 201 to display the parking date and parking time. The electronic paper 201 is composed of multiple colored particles. The driver 202 controls disposition of the colored particles to display the parking date and the parking time. When the electronic paper 201 is inactivated, the disposition of the colored particles is maintained and unchanged. The driver 202 is activated by the detecting current of the coil 12 instead of a battery. Each time the coil 12 induces the detecting current, the driver 202 changes and rearranges the disposition of the colored particles, such that the electronic paper 201 is rewritable. The ticket-token of the invention can be recycled and reused.

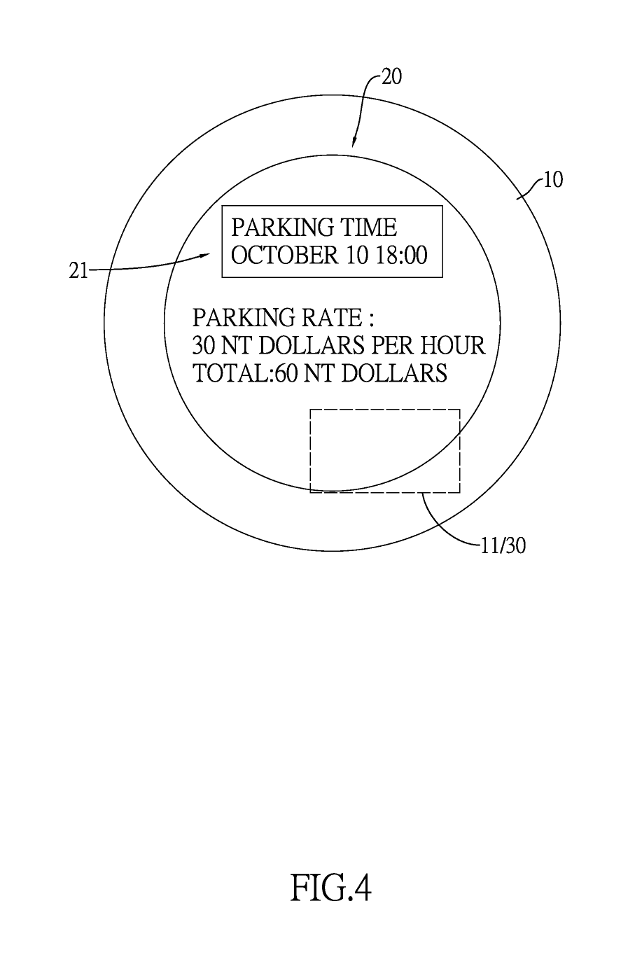

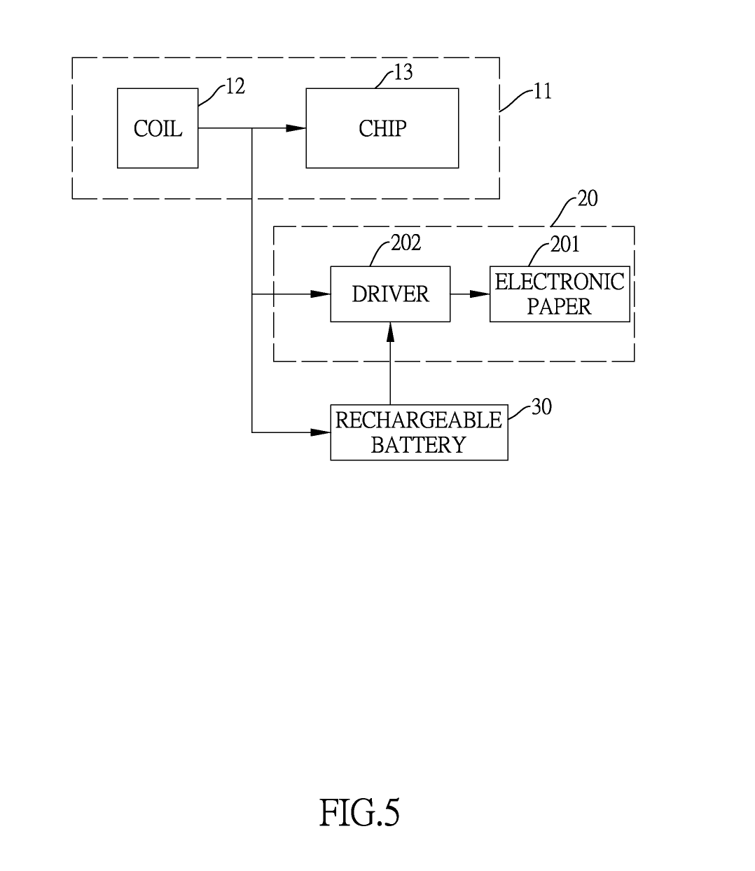

With reference to FIGS. 4 and 5, a rechargeable battery 30 can be mounted in the token body 10 and is electrically connected to the coil 12 and the driver 202. The rechargeable battery 30 can be charged by the detecting current of the coil 12 and provide a working voltage to the driver 202. The driver 202 of the displaying unit 20 is preset with a parking rate and executes a fee calculating process.

When the driver 202 executes the fee calculating process, the driver 202 calculates a parking duration extending from the parking time to a present time and multiplies the parking duration by the parking rate to obtain a parking fee. When the driver 202 obtains the parking fee, the driver 202 activates the electronic paper 201 to display the parking fee. Hence, the user can instantly know how much parking fee has been accumulated anytime within the parking duration.

In addition, with reference to FIG. 3B, in a third embodiment, the displaying unit 20′ comprises an LCD (liquid crystal display) panel 203 and a driver 204. The LCD panel 203 as the indicator 21 is electrically connected to the driver 204. A rechargeable battery 30 is electrically connected to the driver 204 and the LCD panel 203 for providing the working voltage. The driver 204 is electrically connected to the LCD panel 203 and the coil 12. When the coil 12 induces the detecting current, the driver 204 acquires the information of parking date and parking time and activates the LCD panel 203 to display the parking date and the parking time.

The parking rate can be directly preset in the driver 202, or the ticket machine can generate a wireless RF signal containing the parking rate. When the coil 12 receives the wireless RF signal, the coil 12 correspondingly generates a rate-setting current and the driver 202 updates the parking rate according to the rate-setting current.

For example, the parking rate can be 20 NT dollars per hour during weekdays. The parking rate can be 30 NT dollars per thirty minutes during holidays. The ticket-token displays the parking rate. Therefore, the user can be accurately informed of the parking duration and the present parking rate. The user will not calculate a parking fee incorrectly even though the parking rate varies depending on time, date and the parking facility.

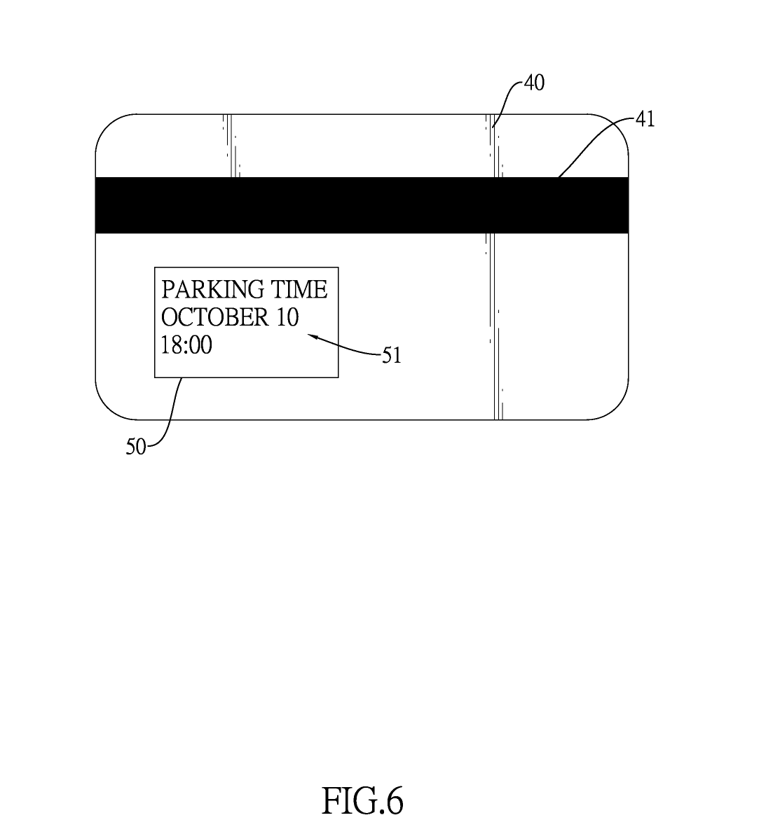

With reference to FIG. 6, a ticket-card of the invention comprises a card body 40, a storage module 41 and a displaying unit 50.

The storage module 41 is mounted on the card body 40 to store parking date and parking time. In this embodiment, the storage module 41 is a magnetic stripe.

The displaying unit 50 is mounted on the card body 40 and has an indicator 51. The indicator 51 displays the parking date and the parking time. In this embodiment, the indicator 51 is a thermal rewrite card.

Taking the thermal rewrite card as the displaying unit 20 as an example, when the ticket machine provides the ticket-token or the ticket-card to the user, the printer of the ticket machine writes the parking date and the parking time to the thermal rewrite card. The user can check the parking time anytime within the parking duration. When the ticket-token and the ticket-card are recycled, the parking date and the parking time are then erased.

Taking the electronic paper and the driver acting as the displaying unit 20 for an example, the ticket machine generates a wireless RF signal containing information of parking date and parking time to the coil 12. When the coil 12 detects the wireless RF signal, the coil 12 generates the detecting current and the chip 13 stores the parking date and the parking time according to the detecting current. The driver activates the electronic paper to display the parking rate, the parking date and the parking time. The user can obtain the parking information by viewing the electronic paper.

In conclusion, the displaying unit displays the information of the parking date and the parking time. The user can check the parking time anytime within the parking duration for time management, and the parking fee can be accurately calculated.

What is claimed is:

1. A ticket-token comprising:
a token body;
a storage module embedded in the token body and having:
a coil inducing a detecting current according to a wireless RF signal containing information of parking time; and
a chip electrically connected to the coil and storing the parking time according to the detecting current of the coil; and
a displaying unit mounted on the token body and having an indicator for displaying the parking time.

2. The ticket-token as claimed in claim 1, wherein the displaying unit has
an electronic paper acting as the indicator and mounted on the token body; and
a driver embedded in the token body, electrically connected to the coil and activating the electronic paper to display the parking time according to the detecting current.

3. The ticket-token as claimed in claim 1 further comprising a rechargeable battery electrically connected to the displaying unit and the coil, wherein the displaying unit has:
an LCD panel acting as the indicator and mounted on the token body; and
a driver embedded in the token body, electrically connected to the coil and the LCD panel, and activating the LCD panel to display the parking time according to the detecting current.

4. The ticket-token as claimed in claim 1, wherein the indicator is a thermal rewrite card.

5. The ticket-token as claimed in claim 2 further comprising a rechargeable battery embedded in the token body, wherein
the rechargeable battery is electrically connected to the coil and the driver; and
the driver executes a fee calculating process to acquire a parking duration extending from the parking time to a present time, to multiply the parking duration by a parking rate to obtain a parking fee, and to activate the electronic paper to display the parking fee.

6. The ticket-token as claimed in claim 3 further comprising a rechargeable battery embedded in the token body, wherein
the rechargeable battery is electrically connected to the coil and the driver; and
the driver executes a fee calculating process to acquire a parking duration extending from the parking time to a present time, to multiply the parking duration by a parking rate to obtain a parking fee, and to activate the LCD panel to display the parking fee.

7. A ticket-card comprising:
a card body;
a storage module mounted on the card body for storing information of parking time; and
a displaying unit mounted on the card body and having an indicator for displaying the parking time.

8. The ticket-card as claimed in claim 7, wherein the indicator is a thermal rewrite card.

9. The ticket-card as claimed in claim 7, wherein the storage module is a magnetic stripe.

10. The ticket-card as claimed in claim 8, wherein the storage module is a magnetic stripe.
